(19) United States
(12) Patent Application Publication
(10) Pub. No.: US 2010/0323914 A1
(43) Pub. Date: Dec. 23, 2010

(54) Enzymatic Methods for Genotyping on Arrays

(75) Inventor: Glenn K. Fu, Dublin, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: AFFYMETRIX, INC., Santa Clara, CA (US)

(21) Appl. No.: 12/822,179

(22) Filed: Jun. 23, 2010

Related U.S. Application Data
(60) Provisional application No. 61/219,707, filed on Jun. 23, 2009.

(51) Int. Cl. C40B 30/04

(52) U.S. Cl. 506/9

(57) ABSTRACT

Disclosed are methods for enzymatic genotyping of polymorphisms on solid supports. In one aspect the method includes hydrolysis of a nucleotide comprising a label on an array-bound probe by a 5′ to 3′ exonuclease activity specific for single-stranded DNA. If there is target-probe sequence mismatch at the polymorphic position (the labeled nucleotide in the probe), the labeled nucleotide is hydrolyzed from the probe by the exonuclease. The presence of a detectable signal on the array is indicative of the identity of the nucleotide at the polymorphic position in the target. In another aspect, the queried position on the probe may be a labeled ribonucleotide, and if there is a sequence mismatch at the polymorphic position on the probe, the labeled ribonucleotide will be hydrolyzed from the nucleic acid by the activity of an exoribonuclease enzyme specific for single-stranded sequences.

### RELATED APPLICATIONS

This application claims priority to U.S. Provisional application No. 61/219,707 filed Jun. 24, 2009, the entire disclosure of which is incorporated herein by reference in its entirety.

### FIELD OF THE INVENTION

The present invention provides methods for genotyping using arrays of nucleic acid probes. The invention relates to diverse fields, including genetics, genomics, biology, population biology, medicine, and medical diagnostics.

### BACKGROUND OF THE INVENTION

Recent progress and research in the genetics field has provided a dynamic change in the ability of science to comprehend vast amount of genomic data. Pioneering technologies such as nucleic acid arrays allow scientists to obtain genetic information in far greater detail than ever before. Recent efforts in the scientific community, including the publication of a haplotype map of the human genome (IHMC, Nature, 437:1299-1320 (2005)), have made genome exploration more feasible. However, genome-wide assays must address the size and complexity of genomes. For instance, the human genome is estimated to comprise 3×10⁹ base pairs.

Because of their abundance, single nucleotide polymorphisms (SNPs) have emerged as the marker of choice for genome-wide association studies and genetic linkage studies. High throughput methods for determining the genotypes of millions of SNPs in an individual will provide the framework for new studies to identify the underlying genetic basis of complex diseases such as cancer, mental illness and diabetes.

For microarray-based genotyping methods, enzymatic reactions performed using in situ synthesized oligonucleotides promise to offer a significant reduction in the number of probes required for DNA sequence determination. For genotyping assays on high density DNA arrays, such probe number reduction may lead to a corresponding increase in the number of genotypes that can be assayed on a given microarray. In the methods disclosed herein, the enzymatic activities of exonucleases, including RNases and DNases are utilized to determine nucleotide sequence identity at a predetermined polymorphic position.

### SUMMARY OF THE INVENTION

Methods for genotyping polymorphisms and particularly SNPs are disclosed. In preferred aspects the methods are enzymatic methods for the conditional enzymatic removal of a label on a probe bound to a solid support, thereby allowing determination of the identity of a polymorphic nucleotide.

In one aspect of the invention, the method of the invention utilizes the exonuclease activity of an enzyme to remove a label on a probe that does not perfectly complement the target nucleic acid at the polymorphic position. In the method, the array probe hybridizes to the target nucleic acid. The probe is designed such that the labeled base on the probe is directly adjacent to the unknown base on the target nucleic acid at the polymorphic position. The probe further comprises a 7-10 nucleotide sequence which is noncomplementary, immediately 5′ to the labeled base at the polymorphic site. Following hybridization to the microarray, the single-stranded, noncomplementary portion of the probe, including the label on probes that do not perfectly complement the target at the polymorphic site, is removed by an exonuclease possessing 5′ to 3′ exonuclease activity. In one embodiment of the invention, the enzyme may be E. coli RecJ, which has highly processive 5′ to 3′ exonuclease activity specific to single-stranded DNA.

In another aspect the labeled base on the probe is a labeled ribonucleotide and the removal of the label is achieved by treatment with RNAse.

The target to be hybridized to the array probes may be reduced in complexity, for example by WGSA or multiplex amplification methods, or it may be a whole genome or WGA product. Detection of labeled probe-target complexes may be accomplished by, for example, measuring the presence of a fluorescence signal.

### BRIEF DESCRIPTION OF THE FIGURES

FIG. 1 depicts hybridization of a target to an array probe. On the left side, the identity of the nucleotide at the polymorphic position is complementary to the target and the label survives exonuclease treatment. However, on the right side, the labeled base on the probe having a noncomplementary nucleotide at the polymorphic position is removed by treatment with a 5′ to 3′ exonuclease. Thus, signal is detected only when the identity of the nucleotide at the polymorphic position is complementary to the target sequence at that position.

FIG. 2 illustrates a similar concept as shown in FIG. 1. In FIG. 2, the probe is RNA and the labeled base on the probe is a labeled ribonucleotide. The labeled ribonucleotide is removed by RNAse treatment when the nucleic acid target and probe are not complementary at the polymorphic position.

### DETAILED DESCRIPTION OF THE INVENTION

Reference will now be made in detail to exemplary embodiments of the invention. While the invention will be described in conjunction with the exemplary embodiments, it will be understood that they are not intended to limit the invention to these embodiments. On the contrary, the invention is intended to encompass alternatives, modifications and equivalents, which may be included within the spirit and scope of the invention.

The invention relates to diverse fields impacted by the nature of molecular interaction, including chemistry, biology, medicine and diagnostics. Methods disclosed herein are advantageous in fields, such as those in which genetic information is required quickly, as in clinical diagnostic laboratories or in large-scale undertakings such as the Human Genome Project.

The present invention has many embodiments and relies on many patents, applications and other references for details known to those of the art. Therefore, when a patent, application, or other reference is cited or repeated below, it should be understood that the entire disclosure of the document cited is incorporated by reference in its entirety for all purposes as well as for the proposition that is recited. All documents, i.e., publications and patent applications, cited in this disclosure, including the foregoing, are incorporated herein by reference in their entireties for all purposes to the same extent as if each of the individual documents were specifically and individually indicated to be so incorporated herein by reference in its entirety.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including, but not limited to, mammals, plants, bacteria, or cells derived from any of the above.

Throughout this disclosure, various aspects of this invention can be presented in a range format. It should be understood that when a description is provided in range format, this is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of one of skill in the art. Such conventional techniques include polymer array synthesis, hybridization, ligation, and detection of hybridization using a detectable label. Specific illustrations of suitable techniques are provided by reference to the examples hereinbelow. However, other equivalent conventional procedures may also be employed. Such conventional techniques and descriptions may be found in standard laboratory manuals, such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995), Biochemistry, 4th Ed., Freeman, N.Y., Gait, Oligonucleotide Synthesis: A Practical Approach, (1984), IRL Press, London, Nelson and Cox (2000), Lehninger, Principles of Biochemistry, 3^{rd} Ed., W.H. Freeman Pub., New York, N.Y., and Berg et al. (2002), Biochemistry, 5^{th} Ed., W.H. Freeman Pub., New York, N.Y., all of which are herein incorporated in their entirety by reference for all purposes.

The present invention may employ solid substrates, including arrays in some embodiments. Methods and techniques applicable to polymer (including protein) array synthesis have been described in U.S. Ser. No. 09/536,841 (abandoned), WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, and in PCT Applications Nos. PCT/US99/00730 (International Publication No. WO 99/36760) and PCT/US01/04285 (International Publication No. WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include, but are not limited to, those that are commercially available from Affymetrix (Santa Clara, Calif.) under the brand name GENECHIP®. Example arrays are shown on the Affymetrix web site.

The present invention contemplates many uses for polymers attached to solid substrates. These uses include, but are not limited to, gene expression monitoring, profiling, library screening, genotyping and diagnostics. Methods of gene expression monitoring and profiling are described in U.S. Pat. Nos. 5,800,992, 6,013,449, 6,020,135, 6,033,860, 6,040,138, 6,177,248 and 6,309,822. Genotyping methods, and uses thereof, are disclosed in U.S. patent application Ser. No. 10/442,021 (abandoned) and U.S. Pat. Nos. 5,856,092, 6,300,063, 5,858,659, 6,284,460, 6,361,947, 6,368,799, 6,333,179, and 6,872,529. Other uses are described in U.S. Pat. Nos. 5,871,928, 5,902,723, 6,045,996, 5,541,061, and 6,197,506.

The present invention also contemplates sample preparation methods in certain embodiments. Prior to, or concurrent with, genotyping, the genomic sample may be amplified by a variety of mechanisms, some of which may employ PCR. (See, for example, PCR Technology: Principles and Applications for DNA Amplification, Ed. H. A. Erlich, Freeman Press, NY, N.Y., 1992; PCR Protocols: A Guide to Methods and Applications, Eds. Innis, et al., Academic Press, San Diego, Calif., 1990; Mattila et al., Nucleic Acids Res., 19:4967, 1991; Eckert et al., PCR Methods and Applications, 1:17, 1991; PCR, Eds. McPherson et al., IRL Press, Oxford, 1991; and U.S. Pat. Nos. 4,683,202, 4,683,195, 4,800,159 4,965,188, and 5,333,675, each of which is incorporated herein by reference in their entireties for all purposes. The sample may also be amplified on the array. (See, for example, U.S. Pat. No. 6,300,070 and U.S. patent application Ser. No. 09/513,300 (abandoned), all of which are incorporated herein by reference).

Other suitable amplification methods include the ligase chain reaction (LCR) (see, for example, Wu and Wallace, Genomics, 4:560 (1989), Landegren et al., Science, 241:1077 (1988) and Barringer et al., Gene, 89:117 (1990)), transcription amplification (Kwoh et al., Proc. Natl. Acad. Sci. USA, 86:1173 (1989) and WO 88/10315), self-sustained sequence replication (Guatelli et al., Proc. Nat. Acad. Sci. USA, 87:1874 (1990) and WO 90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909 and 5,861,245) and nucleic acid based sequence amplification (NABSA). (See also, U.S. Pat. Nos. 5,409,818, 5,554,517, and 6,063,603, each of which is incorporated herein by reference). Other amplification methods that may be used are described in, for instance, U.S. Pat. Nos. 6,582,938, 5,242,794, 5,494,810, and 4,988,617, each of which is incorporated herein by reference.

Additional methods of sample preparation and techniques for reducing the complexity of a nucleic sample are described in Dong et al., Genome Research, 11:1418 (2001), U.S. Pat. Nos. 6,361,947, 6,391,592, 6,632,611, 6,872,529 and 6,958,225, and in U.S. patent application Ser. No. 09/916,135 (abandoned).

Many of the methods and systems disclosed herein utilize enzyme activities. A variety of enzymes are well known, have been characterized and many are commercially available from one or more supplier. For a review of enzyme activities commonly used in molecular biology see, for example, Rittie and Perbal, J. Cell Commun. Signal. (2008) 2:25-45, incorporated herein by reference in its entirety. Exemplary enzymes include DNA dependent DNA polymerases (such as those shown in Table 1 of Rittie and Perbal), RNA dependent DNA polymerase (see Table 2 of Rittie and Perbal), RNA polymerases, ligases (see Table 3 of Rittie and Perbal), enzymes for phosphate transfer and removal (see Table 4 of Rittie and Perbal), nucleases (see Table 5 of Rittie and Perbal), and methylases.

Methods for conducting polynucleotide hybridization assays have been well developed in the art. Hybridization assay procedures and conditions will vary depending on the application and are selected in accordance with known general binding methods, including those referred to in Maniatis et al., Molecular Cloning: A Laboratory Manual, 2^{nd} Ed., Cold Spring Harbor, N.Y, (1989); Berger and Kimmel, Methods in Enzymology, Guide to Molecular Cloning Techniques, Vol. 152, Academic Press, Inc., San Diego, Calif. (1987); Young and Davism, Proc. Nat'l. Acad. Sci., 80:1194 (1983). Methods and apparatus for performing repeated and controlled hybridization reactions have been described in, for example, U.S. Pat. Nos. 5,871,928, 5,874,219, 6,045,996, 6,386,749, and 6,391,623, each of which are incorporated herein by reference.

The present invention also contemplates signal detection of hybridization between ligands in certain embodiments. (See, U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,225,625, U.S. patent application Ser. No. 10/389,194 (U.S. Patent Application Publication No. 2004/0012676) and PCT Application PCT/US99/06097 (published as WO 99/47964), each of which is hereby incorporated by reference in its entirety for all purposes).

The practice of the present invention may also employ conventional biology methods, software and systems. Computer software products of the invention typically include, for instance, computer readable medium having computer-executable instructions for performing the logic steps of the method of the invention. Suitable computer readable medium include, but are not limited to, a floppy disk, CD-ROM/DVD/DVD-ROM, hard-disk drive, flash memory, ROM/RAM, magnetic tapes, etc. The computer executable instructions may be written in a suitable computer language or combination of several computer languages. Basic computational biology methods which may be employed in the present invention are described in, for example, Setubal and Meidanis et al., Introduction to Computational Biology Methods, PWS Publishing Company, Boston, (1997); Salzberg, Searles, Kasif, (Ed.), Computational Methods in Molecular Biology, Elsevier, Amsterdam, (1998); Rashidi and Buehler, Bioinformatics Basics: Application in Biological Science and Medicine, CRC Press, London, (2000); and Ouelette and Bzevanis Bioinformatics: A Practical Guide for Analysis of Gene and Proteins, Wiley & Sons, Inc., 2^{nd} ed., (2001). (See also, U.S. Pat. No. 6,420,108).

The present invention may also make use of various computer program products and software for a variety of purposes, such as probe design, management of data, analysis, and instrument operation. (See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170).

Additionally, the present invention encompasses embodiments that may include methods for providing genetic information over networks such as the internet, as disclosed in, for instance, U.S. patent application Ser. No. 10/197,621 (U.S. Patent Application Publication No. 20030097222), Ser. No. 10/063,559 (U.S. Patent Application Publication No. 20020183936, abandoned), Ser. No. 10/065,856 (U.S. Patent Application Publication No. 20030100995, abandoned), Ser. No. 10/065,868 (U.S. Patent Application Publication No. 20030120432, abandoned), Ser. No. 10/328,818 (U.S. Patent Application Publication No. 20040002818, abandoned), Ser. No. 10/328,872 (U.S. Patent Application Publication No. 20040126840, abandoned), Ser. No. 10/423,403 (U.S. Patent Application Publication No. 20040049354, abandoned), and 60/482,389 (expired).

### A. Definitions

The term “array” as used herein refers to an intentionally created collection of molecules which can be prepared either synthetically or biosynthetically. The molecules in the array can be identical or different from each other. The array can assume a variety of formats, including, but not limited to, libraries of soluble molecules, and libraries of compounds tethered to resin beads, silica chips, or other solid supports.

The term “exonuclease” as used herein refers to a family of enzymes (E.C. 3.1.11 to 3.1.16) capable of catalyzing the hydrolysis of phosphodiester bonds resulting in removal of deoxyribonucleotides, and their analogs, serially, i.e. one nucleotide at a time, from the termini of a polydeoxyribonucleotide chain. Exonucleases catalyze the hydrolysis of phosphodiester bonds from either the 5′ terminus or 3′ terminus of a polynucleotide molecule, depending on whether the enzyme possesses 5′ to 3′ exonuclease activity or 3′ to 5′ exonuclease activity, respectively.

The term “exoribonuclease” as used herein refers to enzymes possessing catalytic activity for hydrolyzing single nucleic acids sequentially, i.e. one at a time, from the termini of RNA molecules. Thus, the substrate of exoribonuclease enzymes is a polyribonucleotide, or a polyribonucleotide analog.

To date, at least four eubacterial exonucleases which require their DNA substrate to be single-stranded-DNA (ssDNA) have been identified, including ExoI, ExoVII, ExoX and RecJ. These enzymes participate in homologous recombination and mediate the excision step of methyl-directed mismatch repair in E. coli. (See, Burdett et al., Proc. Natl. Acad. Sci. USA, 98:6765-6770, 2001). ExoI degrades single-stranded DNA in a 3′ to 5′ direction, releasing deoxyribonucleoside 5′-monophosphates in a stepwise manner and leaving 5′-terminal dinucleotides intact. It is inhibited by phosphoryl and acetyl groups blocking the terminal 3′-hydroxyl group. ExoVII utilizes only single-stranded DNA as a substrate and possesses bi-directional (5′ to 3′ and 3′ to 5′) activity. ExoX is capable of degrading both single-stranded DNA and double-stranded DNA in 3′ to 5′ direction.

RecJ also requires single-stranded DNA as substrate and catalyzes the hydrolysis of deoxynucleotide monophosphates in the 5′ to 3′ direction. RecJ is specific for ssDNA because the active site resides in a cleft that is too narrow to accommodate double-stranded DNA. (See, Yamagata et al., Proc. Natl. Acad. Sci. USA, 99(9):5908-5912, 2002). RecJ possesses highly processive exonuclease activity and catalyzes hydrolysis with equal efficiency using both 5′ phosphorylated and 5′ unphosphorylated polynucleotides as substrate. Reaction conditions useful for promoting the DNA binding and exonuclease activities of RecJ are provided in, for instance, Han et al., Nucleic Acids Res., 34(4):1084-91, 2006. Recombinant RecJ is commercially available from New England Biolabs in a recombinant fusion protein form, RecJ_{f}. Single strand DNA binding protein (SSB) may aid recruitment of RecJ.

The term “genome” as used herein includes all of the genetic material in the chromosomes of an organism. DNA obtained from the genetic material in the chromosomes of a particular organism is genomic DNA. A genomic library is a collection of clones made from a set of randomly generated overlapping DNA fragments representing the entire genome of an organism.

The term genotyping refers to the determination of the genetic information an individual carries at one or more positions in the genome. For example, genotyping may comprise the determination of which allele or alleles an individual carries for a single SNP or the determination of which allele or alleles an individual carries for a plurality of SNPs. For example, a particular nucleotide in a genome may be a T in some individuals and a C in other individuals. Those individuals who have a T at the position have the T allele and those who have a C have the C allele. In a diploid organism the individual will have two copies of the sequence containing the polymorphic position so the individual may have a T allele and a C allele or alternatively two copies of the T allele or two copies of the C allele. Those individuals who have two copies of the C allele are homozygous for the C allele, those individuals who have two copies of the T allele are homozygous for the T allele, and those individuals who have one copy of each allele are heterozygous. The alleles are often referred to as the A allele, often the major allele, and the B allele, often the minor allele. The genotypes may be AA (homozygous A), BB (homozygous B) or AB (heterozygous). Genotyping methods generally provide for identification of the sample as AA, BB or AB.

Linkage disequilibrium or allelic association means the preferential association of a particular allele or genetic marker with a specific allele, or genetic marker at a nearby chromosomal location more frequently than expected by chance for any particular allele frequency in the population. For example, if locus X has alleles A and B, which occur at equal frequency, and linked locus Y has alleles C and D, which occur at equal frequency, one would expect the combination AC to occur at a frequency of 0.25. If AC occurs more frequently, then alleles A and C are in linkage disequilibrium. Linkage disequilibrium (or LD) may result, for example, because the regions are physically close, from natural selection of certain combination of alleles or because an allele has been introduced into a population too recently to have reached equilibrium with linked alleles.

A marker in linkage disequilibrium can be particularly useful in detecting susceptibility to disease (or other phenotype) notwithstanding that the marker does not cause the disease. For example, a marker (X) that is not itself a causative element of a disease, but which is in linkage disequilibrium with a gene (including regulatory sequences) (Y) that is a causative element of a phenotype, can be detected to indicate susceptibility to the disease in circumstances in which the gene Y may not have been identified or may not be readily detectable. Studies using panels of human SNPs to identify evidence for linkage between genomic regions and disease phenotypes have been described. See, for example, Boyles et al., Am J Med Genet A. 140(24):2776-85 (2006), Klein et al. Science 308: 385 (2005), Papassotiropoulos et al., Science 314:475-478 (2006), Craig and Stephan, Expert Rev Mol Diagn 5(2):159-70 (2005) and Puffenberger et al., PNAS 101:11689-94 (2004).

The term “hybridization” as used herein refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” Hybridizations are usually performed under stringent conditions, for example, at a salt concentration of no more than 1 M and a temperature of at least 25° C. For example, conditions of 5×SSPE (750 mM NaCl, 50 mM sodium phosphate, 5 mM EDTA, pH 7.4) and a temperature of between 25° C. and 30° C. are suitable for allele-specific probe hybridizations. Hybridization conditions generally suitable for microarrays are described in the Gene Expression Technical Manual, 2004, and the GENECHIP Mapping Assay Manual, 2004, available at Affymetrix.com.

The term “label” as used herein refers to, but is not limited to, a luminescent label, a light scattering label or a radioactive label. Fluorescent labels include, inter alia, the commercially available fluorescein phosphoramidites such as FLUOROPRIME dyle (Pharmacia), FLUOREDITE dye (Millipore) and FAM (ABI). (See, U.S. Pat. No. 6,287,778, incorporated herein by reference).

The terms “oligonucleotide” and “polynucleotide” as used herein refer to a nucleic acid having at least 2, preferably at least 8, and more preferably at least 20 nucleotides in length, or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized, and mimetics thereof. A further example of a polynucleotide of the present invention includes peptide nucleic acid (PNA). The invention also encompasses situations in which there is a nontraditional base pairing such as Hoogsteen base pairing which has been identified in certain tRNA molecules and postulated to exist in a triple helix. The terms “polynucleotide” and “oligonucleotide” are interchangeably used herein.

The term “polymorphism” as used herein refers to the occurrence of two or more genetically determined alternative nucleotide sequences or alleles in a population of individuals. A polymorphic marker, or polymorphic site (polymorphic position), is the locus at which divergence occurs. Preferred markers have at least two alleles, each occurring at a frequency of greater than 1%, and more preferably at a frequency greater than 10% or 20%, of a selected population of individuals. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wild type form. Diploid organisms may be homozygous or heterozygous for allelic forms. A biallelic polymorphism has two forms. A triallelic polymorphism has three forms. Single nucleotide polymorphisms (SNPs) are a type of polymorphism. SNPs are nucleotide positions at which two alternative bases occur at appreciable frequency (>1%) in a given population of individuals. SNPs are the most common type of human genetic variation. A polymorphic site is frequently preceded by, and followed by, highly conserved sequences (e.g., sequences that vary in less than 1/100 or 1/1000 individuals of the populations).

A SNP may arise due to substitution of one nucleotide for another at the polymorphic site. A transition is the replacement of one purine by another purine or one pyrimidine by another pyrimidine. A transversion is the replacement of a purine by a pyrimidine or vice versa. SNPs can also arise from a deletion of a nucleotide or an insertion of a nucleotide relative to a reference allele.

The term “probe” as used herein refers to a surface-immobilized or free-in-solution molecule that can be recognized by a particular target. U.S. Pat. No. 6,582,908 provides an example of arrays having all possible combinations of nucleic acid-based probes having a length of 10 bases, and 12 bases or more. In one embodiment, a probe may consist of an open circle molecule, comprising a nucleic acid having left and right arms whose sequences are complementary to the target, and separated by a linker region. Open circle probes are described in, for instance, U.S. Pat. No. 6,858,412, and Hardenbol et al., Nat. Biotechnol., 21(6):673 (2003). In another embodiment, a probe, such as a nucleic acid, may be attached to a microparticle carrying a distinguishable code. Encoded microparticles which can be used for in-solution array assays are described in, for instance, International Patent Application Publication No. WO 2007/081410, and U.S. patent application Ser. No. 11/521,057 (U.S. Patent Application Publication No. 2008/0038559). Examples of nucleic acid probe sequences that may be investigated by this invention include, but are not restricted to, those that are complementary to genes encoding agonists and antagonists for cell membrane receptors, toxins and venoms, viral epitopes, hormones (for example, opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

The term “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, particles, such as nanoparticles or microparticles, or other geometric configurations. (See, U.S. Pat. No. 5,744,305, for exemplary substrates).

The term “target” as used herein refers to a molecule that has an affinity for a given probe. Targets may be naturally occurring or man-made, i.e. synthetic, molecules. Targets may be employed in their unaltered state, or as aggregates with other species. Targets may be attached, covalently or noncovalently, to a binding member, either directly or through a specific binding substance. Examples of targets which can be employed by this invention include, but are not restricted to, antibodies, cell membrane receptors, monoclonal antibodies and antisera reactive with specific antigenic determinants (such as found in or on viruses or cells, or other materials known to be antigenic), drugs, oligonucleotides, nucleic acids, peptides, cofactors, lectins, sugars, polysaccharides, cells, cellular membranes, and cell organelles. Targets are sometimes referred to in the art as anti-probes. As the term “targets” is used herein, no difference in meaning between this term and the term “anti-probe” is intended. A “probe-target complex” is formed when two macromolecules have combined through molecular recognition to form a complex.

The term “WGSA (Whole Genome Sampling Assay)” refers to a technology that allows the genotyping of thousands of SNPs simultaneously in complex DNA without the use of locus-specific primers. WGSA reduces the complexity of a nucleic acid sample by amplifying a subset of the fragments in the sample. In this technique, a nucleic acid sample is fragmented with one or more restriction enzyme of interest and adaptors are ligated to the digested fragments. A single primer that is complementary to the adaptor sequence is used to amplify fragments of a desired size, for example 400-800 bps or 400-2000 bps, using PCR. Nucleic acid fragments having a length that is outside the selected size range are not efficiently amplified. The processed target is then hybridized to nucleic acid arrays comprising SNP-containing fragments/probes. WGSA is disclosed in, for example, U.S. patent application Ser. No. 10/646,674 (abandoned), Ser. No. 10/316,517 (U.S. Patent Application Publication 2003/0186279, abandoned), Ser. No. 10/316,629 (U.S. Patent Publication 2003/0186280, abandoned), Ser. No. 10/463,991 (U.S. Patent Application Publication 2003/0186280, abandoned), and Ser. No. 10/442,021 (U.S. Patent Application Publication 2007/0065816, abandoned), and U.S. Pat. Nos. 7,097,976, 7,297,778, 7,300,788 and 7,424,368, each of which is hereby incorporated by reference in its entirety for all purposes. Enzymatic methods for genotyping on arrays are disclosed, for example, in U.S. Patent Pub. 20080131894 and in Gunderson et al. Genome Res. (1998) 8(11):1142-1153, which are each incorporated herein by reference in its entirety.

### B. Biochemical Assays for Genotyping Using Arrays

The millions of SNPs that have been identified in the human genome provide a large repository of markers for human variation, allowing construction of increasingly dense SNP maps and tools for analysis of large numbers of individual SNP markers. These tools have the potential of enabling investigators to generate high resolution mapping of complex human genetic traits, to understand the history of human populations, and to examine genomic abnormalities, such as chromosomal copy number changes that lead to cancer and other diseases.

Recent estimates suggest that there may be approximately 5 million SNPs with minor allele frequencies of at least 10%, and possibly as many as approximately 11 million SNPs with minor allele frequencies of at least 1%. (See, Kruglyak and Nickerson, Nat. Genet., 27:234-236, 2001). Millions of human SNPs have been catalogued, many of which are publicly disclosed in databases, such as The SNP Consortium (TSC) Database and the National Center for Biotechnology Information (NCBI) dbSNP repositories. (See, Thorisson and Stein, Nucleic Acids Res., 31:124-127, 2003).

To obtain the most comprehensive genotype information about an individual, a study may determine the genotype of all, or a majority of the ˜11 million known SNPs. This would be costly and time-consuming given current technologies, as well as unnecessary to address many research questions. Instead, researchers can take advantage of the tendency of regions of the genome to travel together as blocks representing regions of high linkage disequilibrium (LD). (See, for example, Conrad et al., Nat. Genet., 38:1251-1260, 2006). Because of LD, it is possible to use a subset of SNPs that are characteristic of blocks of SNPs. The underlying assumption is that if a set of 5-10 SNPs is in high LD the genotype of one or two SNPs within the set can be used as a surrogate to predict the genotype of the other SNPs in the set. LD patterns, however, vary across the human genome with some regions showing high LD and other regions showing low LD. LD also varies within populations. Thus, assumptions based on information obtained from one group of individuals may not be correct for another set of individuals. Methods for selecting an optimized set of SNPs to be used as fixed marker sets in whole-genome association studies have been disclosed. Weight is typically dependent on marker spacing, allele frequency and the ability of a given genotyping assay to accurately and reproducibly make genotyping calls for the selected SNPs.

High density oligonucleotide arrays have been used to investigate polymorphisms (Chee et al., 1996, Science, 274:610-614.), and have been applied to SNP genotyping and mutation detection. (See, Carrasquillo et al., Nat. Genet., 32:237-244, 2002; Fan et al., Genome Res., 10:853-860, 2000; Fan et al., Genomics, 79:58-62, 2002; Hacia et al., Nat. Genet., 22:164-167, 1999; Wang et al., Science, 280:1077-1082, 1998; and Liu et al., Bioinformatics, 19:2397-2403, 2003). Methods for performing ligation on probes bound to solid supports have been disclosed, for example, in Gunderson et al., Genome Res., 8:1142-1153, 1998. The Affymetrix Mapping 500K array, SNP 6.0 array, and similar array products, provides for simultaneous genotyping of more than 500,000 human SNPs. Similar products may allow genotyping of more than 1,000,000 SNPs.

Given the millions of SNPs that are estimated to exist and the large subset of SNPs already disclosed in databases, there is a need to decrease the high number of SNPs to a number that will fit on a small number of microarrays at current feature sizes. Applications of microarrays for SNP genotyping have been described in a number of U.S. Patents and U.S. Patent Applications, including, for instance, U.S. Pat. Nos. 6,300,063, 6,361,947, 6,368,799, 7,097,976, 7,297778, and U.S. patent application Ser. No. 11/075,121 (U.S. Patent Application Publication No. 2005/0260628, abandoned), Ser. No. 10/316,517 (U.S. Patent Application Publication No. 2003/0186279, abandoned), Ser. No. 10/316,629 (U.S. Patent Application Publication No. 2003/0186280, abandoned) and Ser. No. 10/442,021 (abandoned), all incorporated herein by reference in their entireties for all purposes. Methods and arrays for simultaneous genotyping of more than 10,000 SNPs, and more than 100,000 SNPs, have been described, for example, in Kennedy et al., Nat. Biotech., 21:1233-1237, 2003, Matsuzaki et al., Genome Res., 14(3):414-425, 2004, and Matsuzaki et al., Nature Methods, 1:109-111, 2004, all incorporated herein by reference in their entireties for all purposes.

Methods for genotyping polymorphisms using arrays of oligonucleotide probes are disclosed. In some embodiments, methods for on-array, enzyme-based assays are disclosed. Each allele of a polymorphism correlates to a corresponding array probe sequence. The probes further contain a labeled nucleotide at the polymorphic position. In some aspects this position may be positioned 7-10 nucleotides from the 5′ end of the probe. In one aspect, an E. coli enzyme possessing 5′ to 3′ exonuclease activity is used to query nucleotide identity at the polymorphic position. A mismatch at the polymorphic position, between the array probe and the target nucleic acid, will result in formation of single-stranded DNA (ssDNA) at the polymorphic position, and a cleavage of the labeled base by an exonuclease enzyme, yielding no fluorescent signal. In this embodiment, both array probe and target nucleic acid are DNA. However, the present invention is not limited to DNA applications.

For instance, in another aspect, the array probe contains a labeled ribonucleotide at the polymorphic position, and an exoribonuclease possessing 5′ to 3′ exonuclease activity is employed to identify the nucleotide at the polymorphic position in the target.

In other embodiments, high complexity DNA may be hybridized to an array, including whole genome hybridization to a single array. Detection of labeled array probes allows determination of the genotype of polymorphisms in the target.

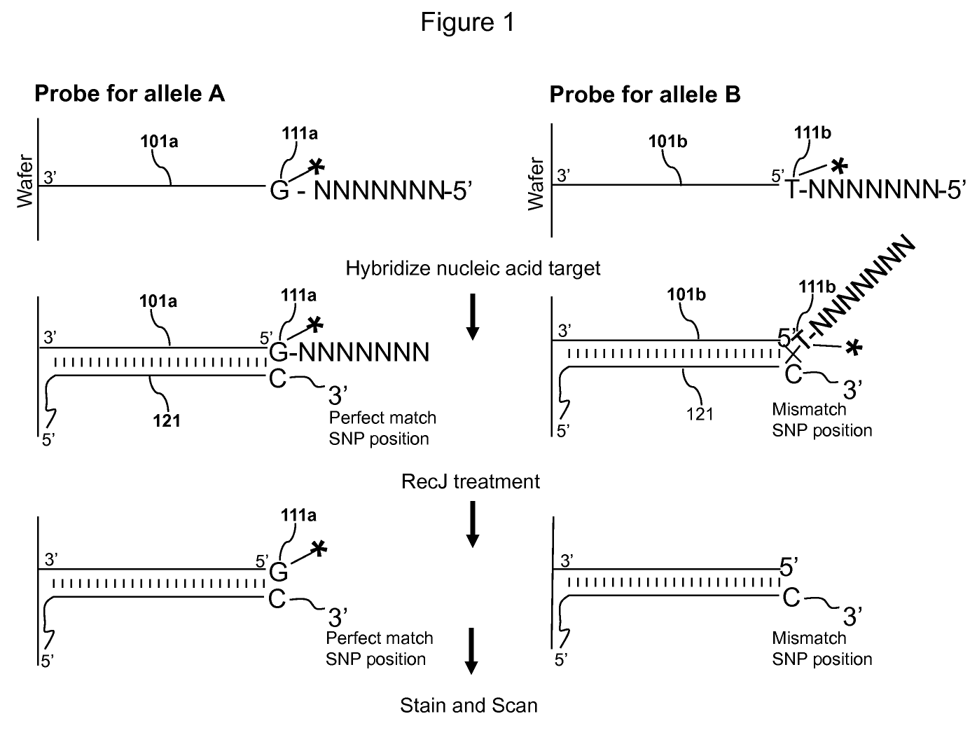

In one embodiment, shown in FIG. 1, there are two array probes, 101a and 101b (collectively, probe 101), that differ only in the identity of the nucleotide at the polymorphic position 111a and 111b (collectively, position 111). The polymorphic position nucleotide is modified to include a label. After the labeled polymorphic position nucleotide, continuing in the 5′ direction, the probe further comprises a noncomplementary sequence of at least 7 nucleotides that is shown in the figure as seven “N”s. However, the N's are preferably fixed so that for each probe and not variable within a specific feature or probe. The N's can be the same for many features, for example they could be a run of a single base, such as T's or A's or a combination of A's and T's. The important aspect is that the overhang is not perfectly complementary with the target in the region immediately 3′ of the interrogation position. The identity of the nucleotide at the polymorphic position 111 is selected to be complementary to one of the polymorphic alleles in the target 121. Depending on which allele is present in the sample, i.e. the target nucleic acid, the polymorphic position will either be complementary to the target at position 121 or it will not be complementary.

If the nucleotide at the polymorphic position 111 is complementary to the nucleotide at position 121 on the target nucleic acid, there will be hybridization at the polymorphic position and formation of double-stranded DNA (dsDNA) at that position. Conversely, if the nucleotide at the polymorphic position 111 is not complementary to the nucleotide at position 121 in the target, then the labeled nucleotide in the probe will not hybridize perfectly to the target 121 and both will be in ssDNA form. In the latter case, where the nucleotides are not complementary, the non-duplexed portion of the probe and target nucleic acids, including the labeled nucleotide, will be removed by addition of a single-strand-specific exonuclease.

In one embodiment, the exonuclease may be E. coli protein RecJ, which is highly processive in the 5′ to 3′ direction in the presence of single-stranded DNA. RecJ requires a single-stranded nucleic acid sequence of at least 7 nucleotides to bind to the substrate. (See, Han et al., Nucleic Acids Res., 34(4):1084-91, 2006) which is incorporated by reference. In the present invention, this exonuclease binding site is provided by the addition of an at least 7-10 nucleotide long noncomplementary sequence, that is positioned immediately 5′ to the labeled polymorphic position nucleotide (111) on the probe and indicated by “NNNNNNN”. The exonuclease will therefore bind to the noncomplementary sequence on the probe, which will be in ssDNA form, and catalyze hydrolysis of nucleotides in the 3′ direction, i.e. towards the labeled polymorphic position nucleotide. If the polymorphic position nucleotide is hybridized to the target nucleic acid, forming dsDNA, the exonuclease activity of RecJ will terminate before hydrolyzing the polymorphic position base. In this case, the label will remain on the array and upon conducting an optional washing step, the label will be detected, indicating the identity of the nucleotide in the target sequence at the polymorphic position.

However, if the polymorphic position nucleotide (111) is not hybridized and is in ssDNA form, the exonuclease will hydrolyze the labeled nucleotide, releasing it into solution. This label will then be washed off the array and no signal will be detected.

In another embodiment, exonuclease VII may be used instead of RecJ. Any exonuclease possessing the required catalytic activity needed to distinguish between ssDNA and dsDNA could be adapted for use in the presently described embodiments.

The label on the probe 101 may be any known, detectable label as disclosed in the prior discussed patents and patent applications, such as, but not limited to, biotin, etc. Such labels may be detected by, for example, fluorescence. Thus, in heterozygous samples containing both of the two alleles of the SNP, both probes 101a and 101b will fluoresce, while homozygous samples will only have either probe 101a or 101b yield a fluorescent signal. Probes that do not contain a complementary base at the polymorphic position will lose their label during hydrolysis catalyzed by the added exonuclease, yielding no signal, i.e. fluorescence.

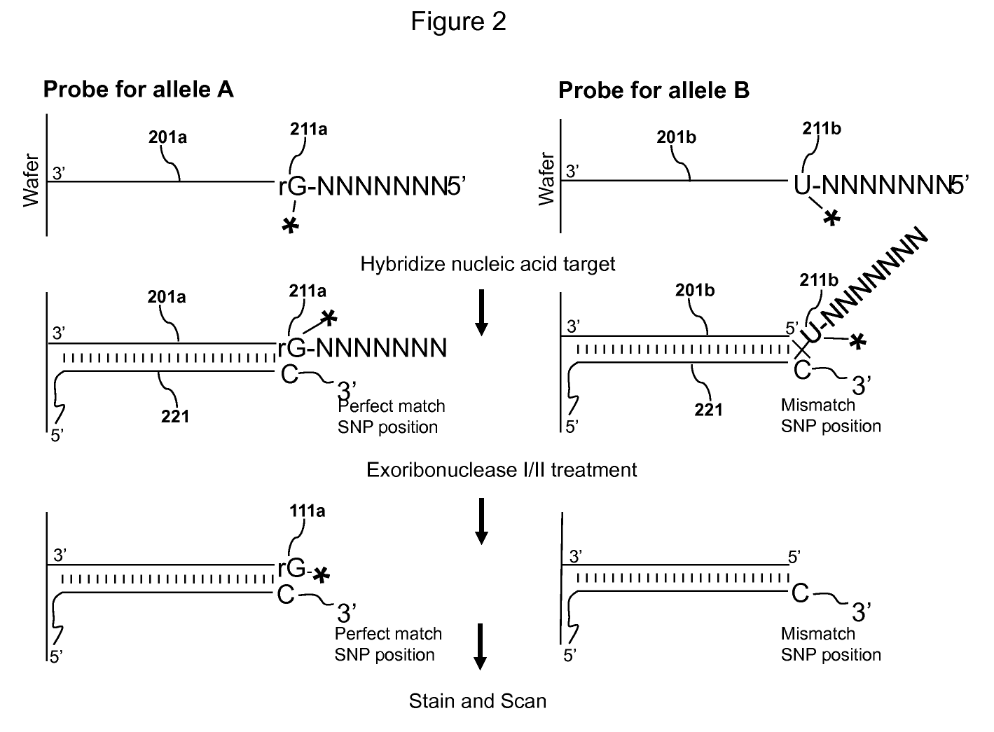

As mentioned, this method is not limited to only DNA applications. An alternative application of this method is illustrated in FIG. 2. In FIG. 2 the polymorphic position on the probe is a labeled ribonucleotide. Exoribonucleases, such as exoribonuclease I and II, are capable of cleaving single-stranded RNA in 5′ to 3′ direction, analogous to RecJ activity on DNA. The remainder of this method parallels that discussed above for DNA applications. Again, any exoribonuclease may be utilized in this embodiment, as long as the enzyme possesses the required catalytic activity and can distinguish between dsRNA and ssRNA.

High density genotyping arrays have recently been used to identify polymorphisms associated with disease. (See, for example, Klein et al., Science, 308:385, 2005, Butcher et al., Behav. Genet., 34(5):549-55, 2004, Gissen et al., Nat. Genet., 36(4):400-4, 2004, and Puffenberger et al., Proc. Nat'l. Acad. Sci. USA, 101(32):11689-11694, 2004). High density genotyping arrays are also used to identify regions of genomic amplification, deletion, loss of heterozygosity (LOH) and allelic imbalance. (See, for example, Cox, et al., Proc. Nat'l. Acad. Sci. USA, 102:4542-47, 2005, Herr et al., Genomics, 85(3):392-400, 2005, and Bignell et al., Genome Res., 14:287-95, 2004). The collection of probes may also be used as a semi-random representation of the entire genome. The array and collection of SNPs may be used for analysis of copy number, methylation, genetic rearrangements and to assess other genomic features.

In some aspects, methods for enhancing hybridization discrimination are disclosed. Genotyping assays based on allele specific hybridization to arrayed probes sometimes rely on specificity of hybridization between perfect match probes and discrimination or mismatch probes to the target DNA. Specificity typically decreases with increasing sequence complexity of the labeled DNA target sequences so these methods often incorporate an upstream complexity reduction step or a step to enrich a subset of targets, thus effectively reducing the complexity. With increased sequence complexity the background hybridization of near matches or partial matches often contribute to a level of hybridization sufficient to reduce the confidence of measurement from the specific perfect match. This can be a greater problem with smaller feature sizes facilitated by improved synthesis methods (“feature” referring to a location on the array where probes having the same sequence are located, often because they have been synthesized in that region or feature). Feature sizes of 4×4 microns are possible and smaller, for example 1×1 microns. The smaller features have fewer probes of a given sequence and fewer pixels are detected during imaging. These smaller features have lower total signal so background signal may have a greater impact on analysis.

One method to increase the specificity of hybridization is to apply more stringent hybridization or washing conditions to reduce the amount of non-specific hybridization. The length and sequence composition of the DNA pairing on the hybridized probes determines the maximum stringency conditions that can be empirically applied. Therefore longer DNA probes may provide for more stringent conditions with high sequence complexity of the target. As the length of the base-pairing increases, the ability to discriminate single base changes at high resolution decreases because Tm differences have a reduced impact and gradually become negligible. Methods are disclosed for using cleavage assays on arrays to increase differences in melting temperature caused by single base mismatches on longer probes. Probe lengths may be 25 to 60 bases, 30 to 60 bases or 26 to 100 bases, for example.

In one aspect an RNA protection assay is used for genotyping or sequencing targets. The RNA or nuclease protection assay may be used to identify individual RNA molecules in a heterogeneous RNA sample.

The probes of the array are DNA and the target to be hybridized to the array is RNA. Genomic DNA, for example, may be first converted to RNA by in vitro transcription using phage RNA polymerase, such as T7, T3 or SP6 RNA polymerase, using methods known in the art. During transcription of the RNA biotinylated nucleotides may be incorporated into the RNA to label the RNA. The RNA is fragmented and hybridized to the arrays of allele specific probes for genotyping, such as the Affymetrix SNP 6.0 array to form RNA-DNA hybrids. Once hybridized the amount of hybridization to the perfect match probes is determined. First the hybridized array is treated with a ribonuclease that specifically cleaves only single stranded RNa but has no activity against RNA in a duplex with either RNA or DNA. Single stranded regions are degraded to short oligomers or to individual nucleotides. RNase, for example T1, A1 or RNase One or a combination of these enzymes. RNase is an enzyme that specifically degrades single stranded RNA. It does not degrade double stranded RNA or RNA hybridized to DNA except in regions where there is a mismatch resulting in a bulge or single stranded region in the RNA. In regions of mismatch between the RNA target and the DNA probe the RNA will be cleaved while the perfect match RNA is left intact. The cleaved RNA will have a lower Tm and can be washed away using a stringent wash condition that distinguishes between full length hybrids and shorter hybrids. The biotin label on the intact hybridized RNA can be detected using standard staining and scanning methods. In another aspect, the hybridized RNA can be labeled with a fluorescent dye using polyA polymerase incorporation after the stringency wash. For related methods see Sandelin, et al. Nature Rev. Genet. 8:424-436 (2007), Melton et al. (1984) NAR 12, 7035 and Gilman, M. (1989) in Current Protocols in Molecular Biology, Vol. 2, Ausubel, F. et al. eds. John Wiley and Sons, New York.

In another aspect methods for array based single-strand endonuclease mismatch cleavage for genotyping or sequencing are disclosed. A DNA endonuclease is used to cleave mismatches on an array of probes. A single stranded DNA nuclease is used to make strand breaks in regions of single-strand including mismatches between DNA targets hybridized to DNA probes, where the probes are attached to a solid support. Nucleases that may be used include, for example, S1 nuclease, mung bean nuclease, CEL-1 nuclease (from celery), T7 endonuclease I, T4 endonuclease VII, bacterial endonuclease V, MutS, MutY, and T7 endonuclease VII (see, for example, Lehman, R. I. in the Enzymes, 3^{rd} ed. (Boyer, P. D. ed) 4, 193-201 (1983) and Viville and Mantovani, Methods Mol. Biol. (1994), 31:299-305). In some aspects P1 nuclease may be used. Conditions for nicking at single base pair mismatches in heteroduplexes may include higher pH, temperature and divalent cation conditions than are routinely used. For conditions and enzymes see Bradley et al. NAR 32(8):2632-2641 (2004). For additional information about single-strand specific nucleases and RNase cleavage based methods for mutation or SNP detection see also Goldrick, Hum Mutat. (2001) 18(3):190-204 and Desai and Shankar, FEMS Microbiol Rev. (2003), 26(5):457-491. Mismatch cleavage by single strand specific nucleases and optimal conditions for performing such analysis are further discussed in Till et al. (2004) NAR 32:2632-41. Different enzymes may have different optimal pH and temperature. For example it has been shown that mung bean performs optimally in a pH range centered around 6.5 at 60° C. and that CEL 1 cleaves optimally at around pH 8 and 37 to 45° C. Varying magnesium or other ion concentration may also result in differences in performance of the enzymes.

Preferably the enzyme activity is selected to cleave regions of single base mismatches of the hybridized DNAs. Advantages of the method may include reducing the need for mismatch probes and an improved accuracy and sensitivity of base-calling algorithms.

In a preferred aspect, the probes on the array are protected from cleavage by inclusion of nuclease resistant linkages. For example, the probes on the array may include one or more of the following modifications: phosphorothioate groups, 2′O-methyls, LNA, or PNA. PNA oligomeric compounds and methods for making them may be found, for example, in U.S. Pat. Nos. 5,539,082; 5,714,331; and 5,719,262, each of which is herein incorporated by reference. Further teaching of PNA compounds can be found in Nielsen et al., Science, 1991, 254, 1497-1500, also incorporated herein by reference. LNA compounds and methods for making the same may be found, for example, in U.S. Pat. Nos. 7,696,345, 7,572,582, 6,268,490 and 6,670,461 which are incorporated herein by reference.

The DNA target may be generated by PCR or whole genome amplification and then purified and fragmented, for example using DNase I. The fragments are hybridized to a genotyping array, for example, the Affymetrix SNP 6.0 array having allele specific probes for human SNPs for allele specific hybridization based genotyping. Following hybridization the mismatches and single stranded regions on the DNA target are cleaved or digested with a single stranded nuclease. Since the arrayed DNA probes are modified they will be resistant to the nuclease activity. The result is unlabeled 25 base targets hybridized to DNA arrays if the sequences are perfect matches. If the hybridization is to a single-base mismatch at the central location of the arrayed probe, then the mismatched base will be cleaved. Following a stringent wash, the mismatched DNAs will preferentially wash away. The residual 25 bases DNA perfect matches hybridized can then be labeled on the array using TdT elongation with a biotinylated nucleoside, such as DLR. The biotin moieties are then stained and scanned to reveal the presence of the prefect matches.

In another aspect, methods for measuring full-length probe quality on arrays is disclosed. The synthesis yield of a given chip can be determined using, for example, DNA staining techniques. Upon binding of several commercially available stains to DNA molecules, these stains exhibit fluorescent properties that can be detected. The intensity of these stains correlates with the amount of DNA probe residing on the arrays, thereby providing a means to make quantitative measurements of probe yield. A second level of internal control may be performed by the inclusion of “control probes” on the arrays. These control probes may be complementary to the sequences of short biotin-labeled control oligonucleotides that are spiked into the hybridization reaction. Examination of the intensity of the control probes post staining can be used to control the quality of the hybridization reaction on the array.

This approach does not discriminate particularly well between full length probes (e.g. 25 bases) and shorter probes (e.g. 24 or fewer). Probes as short as a single 1-mer will also be stained with DNA binding dyes; and probes of 18-20 mers may hybridize to the control oligos spiked into the hybridization reactions. Therefore, an array with a high percentage of non full-length probes (e.g. 24 or less) may perform quite well in the standard quality control assays but may perform poorly in actual hybridization assays because of non full-length probes. Assays based on high complexity targets (such as the WGSA assay or whole genome assays), or assays that are based on small feature sizes (such as 5 micron features or smaller) may be more sensitive to variations in the production process leading to reduction in the number of full length probes.

In some aspects, an RNA oligonucleotide probe may be used in lieu of a DNA control oligo or in combination with a DNA control oligonucleotide. For example, a 25-base RNA probe containing sequences complementary to the control probes tiled on the array, with its 3′ most base complementary to the 5′ most base of the probe may be used. The 3′ end may be synthesized with biotin, or any other fluorescent dye conjugate, and the 5′ end is synthesized with a second fluorescent dye conjugate (such as fluorescein). The RNA control oligonucleotide is used in a similar fashion to the DNA control oligonucleotide in a hybridization reaction, except post-hybridization, during the array staining process, RNase ONE ribonuclease, or another single strand specific ribonuclease is added to the stain solution. If the DNA probe on the array is shorter than 25 bases, the 3′ end of the RNA probe will hang over as a single stranded overhang and that single stranded region (with the label) will be cleaved by the ribonuclease, causing a loss of signal from the coupled dye, for example, loss of fluorescent emission. If the DNA probe is a full-length 25 mer, hybridization of the 3′ base of the RNA oligonucleotide “protects” the RNA from single-stranded attack by the RNAse enzyme, thereby leading to a positive readout from the coupled dye molecule. The 5′ end of the RNA oligo will serve as a control with the intensity of the dye coupled at this end detected simultaneously by scanning at a different emission wavelength. This assay will be particularly useful in applications where the DNA probes are synthesized in a 5′ to 3′ orientation (3′ up) for applications where the presence of the 3′ end of the full-length probe is important for the assay to work. In another aspect, this quality assessment assay can be used alone without DNA targets, for example, in making quantitative determinations of the ratio of full-length to non-full length probes on a given array during array manufacturing quality control.

### Examples

### Example I

### Determination of Sequence Identity of Target Nucleic Acid by Hybridization of Target Nucleic Acid to a Biotinylated DNA Probe, Followed by RecJ Exonuclease Treatment

Preparation of Arrays and Probes. Biotin-labeled, array-bound DNA probes may be prepared directly by solid-phase sequential DNA synthesis on the array. Alternatively, the 5′ noncomplementary sequence of at least 7 nucleotides, adjacent to the labeled polymorphic site nucleotide, may be generated separately and added to the probe either by enzymatic extension (e.g. by terminal deoxynucleotidyl transferase (TdT) or another DNA polymerase), or by ligating together two oligonucleotides to generate the full length probe.

Preparation of Sample Target Nucleic Acid. The target nucleic acid (e.g. genomic DNA, or human genomic DNA) may be enzymatically fragmented by DNAse I treatment. For example, a total of 1.5 μg of genomic DNA may be incubated with DNAse I at a final concentration of 5 ng/mL in a reaction volume of 10 μl, in 1× fragmentation buffer. The reaction may be incubated at 37° C. for 10 minutes, then 95° C. for 10 minutes, and then maintained at 4° C. The fragmented sample may then be used directly for hybridization onto the array. Alternatively, specific fragments may be enriched in the sample, for example by multiplex amplification methods.

Hybridization of Target Nucleic Acids to Array. Aliquots of unlabeled fragmented sample DNA may be hybridized to the prepared arrays with probes, wherein the probes (attached to the arrays) comprise sequences which are complementary to, for example, human genomic sequences comprising polymorphisms. A modified version of the ENCODE array may be used for this purpose, where the polymorphic position in the probe is located at nucleotide position number 25, which is then followed by an at least 7 nucleotide length noncomplementary 5′ sequence, providing a total probe length of at least 32 bases. Hybridization reactions may be conducted by mixing fragmented DNA diluted in water with hybridization master mix (for 20.9 mL of hybridization mix, mix together 1320 μl 1.25 M MES, 1430 μl 50× Denhart's solution, 320 μl 0.5 EDTA pH 8.0, 330 μl HSDNA (10 mg/mL), 220 μl OCR, 330 μl human Cot-1 DNA (1 mg/mL), 110 μl Tween 20 (3%), 1430 μl DMSO, and 1540 μl 5M TMACl). This mixture may then be hybridized to arrays. This step may be optionally followed by washing steps performed at 37° C. with 0.2× wash buffer (Wash A: 6×SSPE, 0.01% Tween-20; Wash B: 0.6×SSPE, 0.1% Tween-20), for 30 minutes.

Exonuclease Treatment. After hybridization of the target nucleic acids to the array probes, the probe-target complexes may be incubated with an effective amount of an appropriate exonuclease, for instance, RecJ exonuclease, in a buffer containing 10 mM Tris (pH 8.0), 50 mM NaCl, 25 mM EDTA, 25% glycerol and 1 mM DTT. RecJ-DNA binding reactions may be incubated on ice for 1 hour, followed by TE washes at 37° C. for 15 minutes each wash.

Visualization of Signal and Determination of Identity of Nucleotide at the Polymorphic Position. The staining and scanning of labeled probes on the arrays may be performed as described previously. (See, for example, GENECHIP Mapping 500K Assay Manual, Rev. 3, Chapter 5). Detection of a signal at a feature comprising a known probe sequence indicates the identity of the nucleotide at the polymorphic position of the target nucleic acid. That is, since the sequence identity of each probe is known, and since signal may be detected at any given position on the array comprising a known probe sequence, the signal may be correlated with the sequence at that position on the array. The target nucleic acid polymorphic position nucleotide identity will be the nucleotide which is complementary to the nucleotide at the polymorphic position in the probe, i.e. the labeled nucleotide.

### Example 2

### Determination of Sequence Identity of Target RNA by Hybridization of Target Nucleic Acid to a Biotinylated DNA Probe, Followed by Exoribonuclease Treatment

This assay may be conducted essentially as described above, for application to DNA molecules. That is, the prepared sample contains ribonucleic acid (RNA), instead of DNA sequences. These RNA target sequences may be prepared as above, or according to previously discussed and known sample preparation procedures for RNA, and then hybridized to the array comprising the sequences described herein, designed to determine the identity of the ribonucleotide at the polymorphic position on the target RNA sequence. Instead of using exonuclease, an effective amount of an appropriate exoribonuclease may be employed in the hydrolysis step, thereby eliminating any single-stranded sequences on the array. Detection of signal may be conducted as above and determination of the identity of the ribonucleotide at the polymorphic position may also be conducted as above.

What is claimed is:

1. A method for genotyping a target polymorphism in a nucleic acid sample comprising:
a) providing an array comprising a plurality of features
wherein each feature comprises a plurality of probes having the same sequence;
wherein the probes in a feature are perfectly complementary to the sequence that is immediately adjacent to a target polymorphism in a target sequence;
wherein a first subset of the features comprise probes that are perfectly complementary to a first allele of the target polymorphism but not to a second allele of the target polymorphism;
wherein a second subset of the features comprises probes that are perfectly complementary to the second allele of the target polymorphism;
wherein the probe position corresponding to the target polymorphism is modified to include a detectable label; and
wherein the probe further comprises a noncomplementary polynucleotide sequence of at least 7 nucleotides immediately 3′ to the probe position corresponding to the target polymorphism;
b) hybridizing the nucleic acid sample to the array to allow formation of probe-target complexes;
c) adding an effective amount of an exonuclease enzyme possessing a 5′ to 3′ exonuclease activity that is specific for single-stranded DNA;
d) determining the genotype of a polymorphism by detection of the presence of the label either:
i) on the probe complementary to the first allele of a target polymorphism,
ii) on the probe complementary to the second allele of a target polymorphism, or
iii) on both probes complementary to the first and second alleles of a target polymorphism, respectively.

2. The method according to claim 1, wherein the label is biotin.

3. The method according to claim 1, wherein the noncomplementary polynucleotide sequence is at least 10 nucleotides in length.

4. The method according to claim 1, wherein the exonuclease is RecJ.

5. The method according to claim 1, wherein the exonuclease is Exo VII.

6. The method according to claim 1, wherein the nucleic acid sample is unamplified genomic DNA.

7. The method according to claim 1, wherein the nucleic acid sample is genomic DNA that has been enriched for a subset of target sequences.

8. The method according to claim 1, wherein the full length array probes have a sequence length of between 15 nucleotides and 55 nucleotides.

9. The method according to claim 1, wherein the full length array probes have a sequence length of between 50 nucleotides and 71 nucleotides.

10. The method according to claim 1, wherein the full length array probes have a sequence length of between 26 nucleotides and 30 nucleotides.

11. The method according to claim 1, wherein formamide is added to the step of hybridizing the nucleic acid sample.

12. The method according to claim 1, wherein yeast RNA is added to the step of hybridizing the nucleic acid sample.

13. A method for genotyping a target polymorphism in a ribonucleic acid sample comprising:
a) providing an array comprising a plurality of features
wherein each feature comprises a plurality of probes comprising the same sequence;
wherein the probes in a feature are perfectly complementary to the sequence that is immediately adjacent to a target polymorphism in a target sequence;
wherein a subset of the features comprise probes that are perfectly complementary to a first allele of the target polymorphism but not to a second allele of the target polymorphism;
wherein another subset of the features comprises probes that are perfectly complementary to the second allele of the target polymorphism;
wherein the probe position corresponding to the target polymorphism is modified to include a detectable label; and
wherein the probe further comprises a noncomplementary polynucleotide sequence of at least 7 nucleotides immediately 3′ to the probe position corresponding to the target polymorphism;
b) hybridizing the ribonucleic acid sample to the array to allow formation of probe-target complexes;
c) adding an effective amount of an exoribonuclease enzyme possessing a 5′ to 3′ exonuclease activity, wherein substrate for the exoribonuclease enzyme must be single-stranded nucleic acid;
d) determining the genotype of a polymorphism by detection of the presence of the label either:
i) on the probe complementary to the first allele of a target polymorphism,
ii) on the probe complementary to the second allele of a target polymorphism, or
iii) on both probes complementary to the first and second alleles of a target polymorphism, respectively.

14. The method according to claim 13, wherein the label is biotin.

15. The method according to claim 13, wherein the noncomplementary polynucleotide sequence is at least 10 nucleotides in length.

16. The method according to claim 13, wherein the exoribonuclease is exoribonuclease I or exoribonclease II.

17. The method according to claim 13, wherein the nucleic acid sample is whole genome RNA.

18. The method according to claim 13, wherein the array probes have a sequence length of between 35 nucleotides and 55 nucleotides.

19. The method according to claim 13, wherein formamide is added to the step of hybridizing the nucleic acid sample.

20. The method according to claim 13, wherein yeast RNA is added to the step of hybridizing the nucleic acid sample.
